(19) United States
(12) Patent Application Publication
(10) Pub. No.: US 2008/0068118 A1
(43) Pub. Date: Mar. 20, 2008

(54) Method for adjusting mutual inductance and a transformer that implements the same

(75) Inventors: Masakazu Ushijima, Tokyo (JP); Chun-Yi Chang, Taipei Hsien (TW)

Correspondence Address: PILLSBURY WINTHROP SHAW PITTMAN, LLP, P.O. BOX 10500, MCLEAN, VA, 22102, US

(73) Assignees: GREATCHIP TECHNOLOGY CO., LTD., Taichung (TW); YAO SHENG ELECTRONIC CO., LTD., Taipei Hsien (TW)

(21) Appl. No.: 11/896,986

(22) Filed: Sep. 7, 2007

(30) Foreign Application Priority Data
Sep. 15, 2006 (TW) 095134206
Dec. 11, 2006 (TW) 095221808
Jan. 2, 2007 (TW) 096100048

(51) Int. Cl. H01F 21/06; H01F 27/02

(52) U.S. Cl. 336/90; 336/132

(57) ABSTRACT

A method for adjusting mutual inductance is adapted for use in a transformer including a main core and two windings that are wound on the main core and that have the mutual inductance established therebetween. The method includes the steps of: (A) disposing an adjusting core between the windings and adjacent to the main core, the adjusting core having a cross-sectional area smaller than that of the main core; and (B) without resulting in division of flux of the mutual inductance established between the windings, and division of an exciting magnetic flux into a plurality of independent magnetic paths, adjusting position of the adjusting core relative to the main core to vary the mutual inductance established between the two windings.

### CROSS-REFERENCE TO RELATED APPLICATIONS

This application claims priority of Taiwanese Application Nos. 095134206, 095221808 and 096100048, respectively filed on Sep. 15, 2006, Dec. 11, 2006 and Jan. 2, 2007.

### BACKGROUND OF THE INVENTION

1. Field of the Invention

The invention relates to a method for adjusting mutual inductance, more particularly to a method for adjusting mutual inductance in a transformer, and to a transformer capable of adjusting mutual inductance.

2. Description of the Related Art

Currently, a lot of liquid crystal displays (LCDs) use cold cathode fluorescent lamps (CCFL) as a main source of backlight illumination. Since a high voltage is required for lighting up the CCFL, an inverter circuit composed of inverters is utilized for achieving the same. The inverter circuit adopts an inverter transformer as a booster component thereof. An inverter circuit can use a single inverter transformer to drive a single lamp in a one-to-one configuration, and can also use a single inverter transformer to drive two lamps in a one-to-many configuration. Take a 32-inch LCD as an example, 16 lamps are required for providing the source of backlight illumination. If the one-to-one configuration is used, 16 inverter transformers will be required for driving the lamps. As LCDs increase in physical size, the number of lamps required increases accordingly, thereby increasing the number of required inverter transformers. Therefore, the one-to-many configuration will become the trend in order to minimize production costs.

Shown in FIG. 1 is a first type of a conventional one-to-many transformer 100. The conventional one-to-many transformer 100 includes a bobbin 10, and a core unit 11 coupled to the bobbin 10. A primary winding 101, and two secondary windings 102 coupled magnetically to the primary winding 101 are wound on the bobbin 10. The core unit 11 includes an elongated core 111 extending through the bobbin 10, and two E-shaped cores 112. Each of the secondary windings 102 has a grounded end and an opposite end that is coupled electrically to a corresponding lamp. As shown in FIG. 2, magnetic coupling (K) is established between the primary winding 101 and each of the secondary windings 102. Since the two secondary windings 102 simultaneously sense the exciting magnetic flux of the primary winding 101 in the same magnetic path, mutual inductance (M) is established between the secondary windings 102. If the magnetic coupling (K) established between each of the secondary windings 102 and the primary winding 101 is large, an equivalent circuit of the conventional one-to-many transformer 100 adapted for driving two lamps 12 will be such as that illustrated in FIG. 3, which can be further converted into FIG. 4, where the lamps 12 are connected in parallel such that an overall induced current (I) is equal to the sum of two load currents (I₁, I₂), i.e., (I=I₁+I₂). Since the lamps 12 have different impedances, the load currents (I₁, I₂) have different magnitudes by virtue of the principle of current division. Due to the mutual inductance between the secondary windings 102, output voltages for the lamps 12 are cancelled out or amplified by each other, resulting in unbalanced load currents (I₁, I₂) between the lamps 12, thereby making brightness of light provided by the lamps 12 unstable.

Shown in FIG. 5 and FIG. 6 is a second type of the conventional one-to-many transformer 200. The conventional one-to-many transformer 200 includes two bobbins 20, and a core unit including two U-shaped cores 21. The bobbins 20 are coupled respectively to opposite first and second sides of the core unit. A primary winding 201 is wound on one of the bobbins 20, and two secondary windings 202 are wound on the other one of the bobbins 20. Each of the secondary windings 202 has opposite terminals that are each coupled electrically to a corresponding lamp 22. Magnetic coupling (K) is established between the primary winding 201 and each of the secondary windings 202. Mutual inductance (M) between the secondary windings 202 cannot be avoided since the distance between the secondary windings 202 is small. An equivalent circuit of the conventional one-to-many transformer 200 when the magnetic coupling (K) is large is shown in FIG. 7, which can be further converted into the circuit of FIG. 8, where two parallel load circuits are connected in series such that an overall induced current (I) is equal to the sum of two load currents in each of the loading circuits (I₁+I₂, I₃+I₄), i.e., (I=I₁+I₂=I₃+I₄). Since the lamps 22 have different impedances, the load currents (I₁, I₂, I₃, I₄) have different magnitudes, and the same adverse effects on the brightness of light provided by the lamps 22 are experienced.

In sum, the magnetic coupling (K) between the primary winding 101, 201 and each of the secondary windings 102, 202 should not be too large so as to avoid an equivalent parallel load circuit that can result in unstable brightness of the light provided by the lamps 12, 22. On the other hand, when the magnetic coupling (K) is reduced, leakage current in the secondary windings 102, 202 increases, resulting in ineffective supply of power by the secondary windings 102, 202 to the lamps 12, 22. Therefore, a suitable magnetic coupling (K) is desirable.

Shown in FIG. 9 is a third type of the conventional one-to-many transformer 300. Coil structure of the conventional one-to-many transformer 300 includes a primary winding 301 disposed between two secondary windings 302. Output voltages of the secondary windings 302 are 180 degrees out-of-phase. This configuration has poor magnetic coupling. In addition, as resonance frequencies of resonance circuits established at two output terminals respectively of the secondary windings 302 are different from each other, unbalanced output currents of the secondary windings 302 occur. Moreover, an output traveling wave problem is present in the secondary windings 302, where traveling waves (P1, P2) travel in opposite directions into the secondary windings 302 when effective flux cross-sectional areas of the primary and secondary windings 301, 302 are the same, resulting in magnetic fluxes that are reflected toward each other and that cancel out effective induced fluxes, thereby adversely affecting the exciting magnetic flux of the primary winding 301. In order to avoid the above problem, self-resonant frequencies of the secondary windings 302 need to be relatively high so as to be unaffected by the reflected magnetic fluxes of the secondary windings 302. However, it is necessary to increase the coil numbers of the secondary windings 302 to increase the self-resonant frequencies associated with the same, which results in the problem of reduced magnetic couplings.

Shown in FIG. 10 is a fourth type of the conventional one-to-many transformer 400, which is a dual-magnetic-path transformer structure disclosed in U.S. Patent Application Publication No. 2006/0125591 capable of eliminating the abovementioned shortcomings of the conventional one-to-many transformer 300 shown in FIG. 9. The conventional one-to-many transformer 400 includes two U-shaped cores 41, and a divider core 42. The U-shaped cores 41 cooperate to define opposite first and second side portions that have two primary windings 401 and two secondary windings 402 wound thereon, respectively. The divider core 42 is disposed between the U-shaped cores 41 and extends across the first and second side portions, such that two independent magnetic paths are each formed by a respective pair of the primary and secondary windings 401, 402. Since the divider core 42 simultaneously has two in-phase or out-of-phase exciting magnetic fluxes flowing therethrough, the problem of magnetic saturation needs to be considered. The conventional one-to-many transformer 400 is basically a combination of two one-to-one transformers, where two different exciting magnetic loops are established, and thus does not have the effect of balancing current. Further, since cross-sectional areas of the divider core 42 and two sides 411 of the U-shaped cores 41 that are parallel to the divider core 42 are identical, magnetic coupling (K) cannot be enhanced or adjusted for increasing output power.

As shown in FIG. 11, another conventional transformer 500 includes a coil bracket 50, primary and secondary windings 501, 502 wound on the coil bracket 50, and a loop core 51 extending through the coil bracket 50. A tight coupling is established between the primary winding 501 and one end of the secondary winding 502 that is proximate to the primary winding 501, and a loose coupling is established between the primary winding 501 and the other end of the secondary winding 502 that is distal from the primary winding 501. There are less traveling waves in the loose coupling side, and there is no interference with traveling waves in the tight coupling side. Consequently, a better coupling effect can be obtained by adjusting the coil number of the secondary winding 502. To simultaneously minimize the size of the conventional transformer 500 and enhance transforming efficiency of the conventional transformer 500, resonance (Q) between the secondary winding 502 and a lamp (not shown) connected thereto can be increased, and exciting current of the primary winding 501 can be decreased (which enhances power), thereby reducing required coil number of the primary winding 501, which in turn reduces copper loss.

However, increasing the resonance (Q) causes adverse effects in a one-to-many transformer (e.g., those shown in FIGS. 1, 5, 9 and 10), such as slight differences between resonance frequencies of two adjacent secondary windings, and unbalanced load currents at output ends of the one-to-many transformer.

### SUMMARY OF THE INVENTION

Therefore, the object of the present invention is to provide a method for adjusting mutual inductance established between two windings in a transformer, thereby balancing and stabilizing currents in the windings.

Another object of the present invention is to provide a transformer that implements the method for adjusting mutual inductance established between two windings thereof, so as to balance and stabilize currents in the windings.

According to one aspect of the present invention, there is provided a method for adjusting mutual inductance adapted for use in a transformer including a main core and two windings that are wound on the main core and that have the mutual inductance established therebetween. The method includes the steps of:

(A) disposing an adjusting core between the windings and adjacent to the main core, the adjusting core having a cross-sectional area smaller than that of the main core; and

(B) without resulting in division of flux of the mutual inductance established between the windings, and division of an exciting magnetic flux into a plurality of independent magnetic paths, adjusting position of the adjusting core relative to the main core to vary the mutual inductance established between the two windings.

According to another aspect of the present invention, there is provided a transformer capable of adjusting mutual inductance that includes a main core, two windings, and an adjusting core. The windings are wound on the main core and have the mutual inductance established therebetween. The adjusting core has a cross-sectional area smaller than that of the main core, and is disposed between the windings and adjacent to the main core. Position of the adjusting core relative to the main core is adjustable so as to vary the mutual inductance established between the windings.

### BRIEF DESCRIPTION OF THE DRAWINGS

Other features and advantages of the present invention will become apparent in the following detailed description of the preferred embodiments with reference to the accompanying drawings, of which:

FIG. 1 is a partly exploded perspective view of a first type of a conventional one-to-many transformer;

FIG. 2 is a schematic diagram, illustrating magnetic coupling established between a primary winding and each of secondary windings of the first type of the conventional one-to-many transformer;

FIG. 3 is an equivalent circuit of FIG. 2 when the magnetic coupling established between the primary winding and each of the secondary windings is large;

FIG. 4 is an equivalent diagram of FIG. 3, illustrating a parallel connection of the lamps;

FIG. 5 is a schematic diagram of a second type of the conventional one-to-many transformer;

FIG. 6 is a schematic diagram, illustrating magnetic coupling established between a primary winding and each of secondary windings of the second type of the conventional one-to-many transformer;

FIG. 7 is an equivalent circuit of FIG. 6 when the magnetic coupling established between the primary winding and each of the secondary windings is large;

FIG. 8 is an equivalent circuit of FIG. 7, illustrating two parallel load circuits formed by the lamps;

FIG. 9 is a schematic diagram of a third type of the conventional one-to-many transformer;

FIG. 10 is a perspective view of a fourth type of the conventional one-to-many transformer;

FIG. 11 is a schematic diagram of another conventional transformer;

FIG. 12 is a schematic diagram of a first implementation of the first preferred embodiment of a transformer according to the present invention;

FIG. 13 is a schematic side view of a second implementation of the first preferred embodiment;

FIG. 14 is a partly exploded perspective view of the second implementation of the first preferred embodiment;

FIG. 15 is a perspective view of a third implementation of the first preferred embodiment;

FIG. 16 is a perspective view of a fourth implementation of the first preferred embodiment;

FIG. 17 is an exploded perspective view of a fifth implementation of the first preferred embodiment;

FIG. 18 is an assembled perspective view of the fifth implementation of the first preferred embodiment;

FIG. 19 is a schematic side view of a first implementation of the second preferred embodiment of a transformer according to the present invention;

FIG. 20 is a schematic side view of a second implementation of the second preferred embodiment of a transformer according to the present invention;

FIG. 21 is a perspective view of a third implementation of the second preferred embodiment;

FIG. 22 is a perspective view of a fourth implementation of the second preferred embodiment;

FIG. 23 is a perspective view of a first implementation of the third preferred embodiment of a transformer according to the present invention;

FIG. 24 is a perspective view of a second implementation of the third preferred embodiment;

FIG. 25 is a schematic view of the fourth preferred embodiment of a transformer according to the present invention;

FIG. 26 is a schematic diagram of a first implementation of the fifth preferred embodiment of a transformer according to the present invention;

FIG. 27 is a schematic diagram of a second implementation of the fifth preferred embodiment;

FIG. 28 is a schematic side view of a first implementation of the sixth preferred embodiment of a transformer according to the present invention;

FIG. 29 is a schematic side view of a second implementation of the sixth preferred embodiment; and

FIG. 30 is a schematic diagram of the seventh preferred embodiment of a transformer according to the present invention.

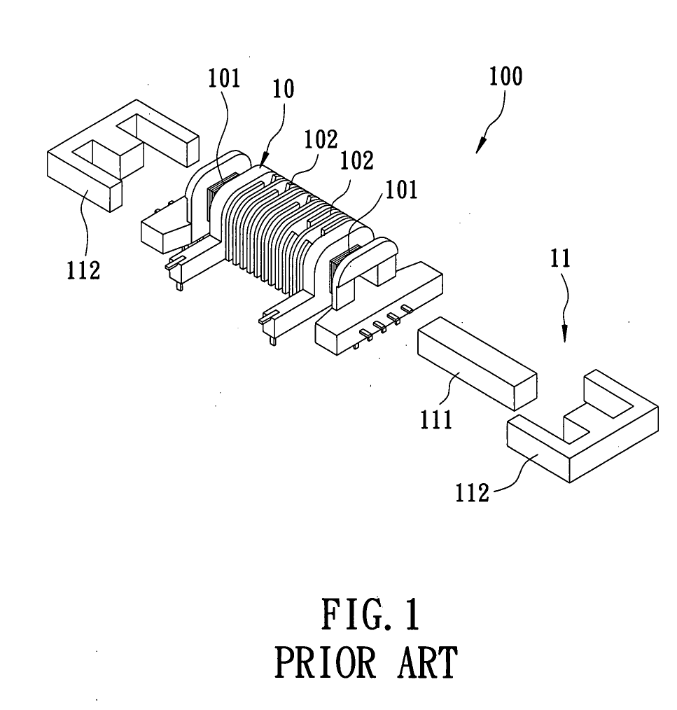

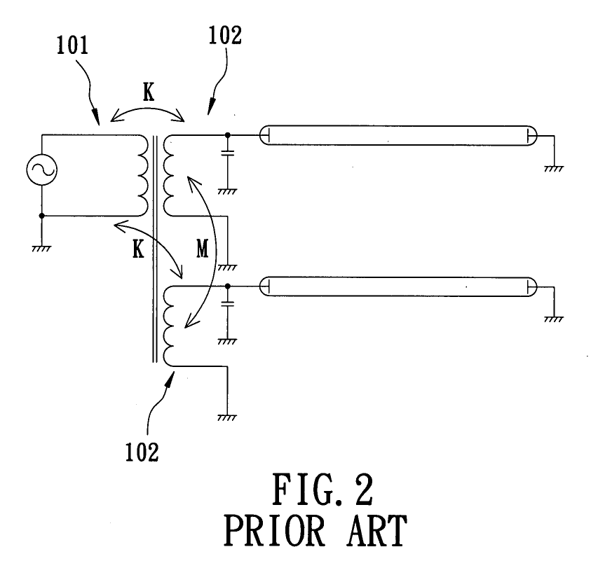

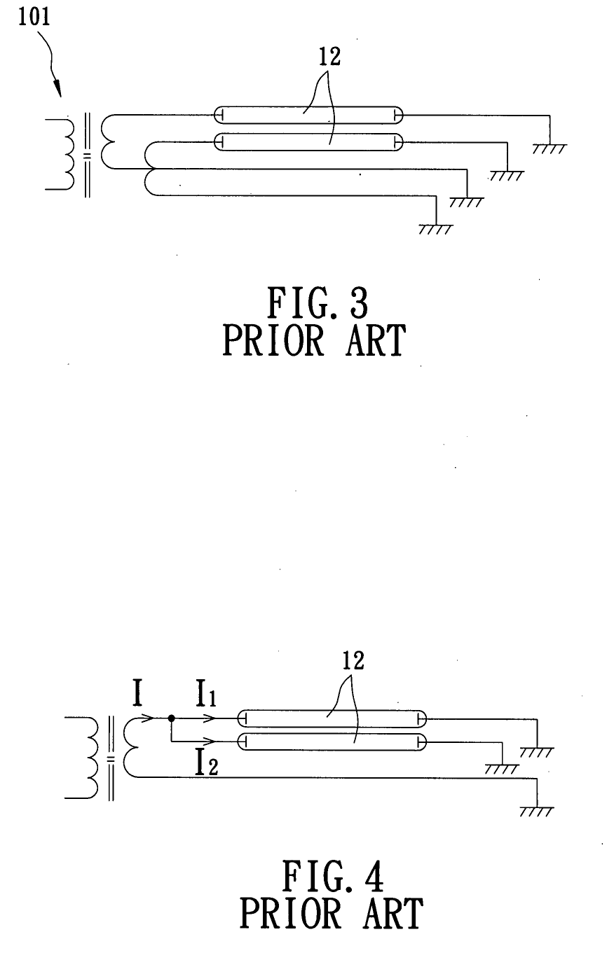

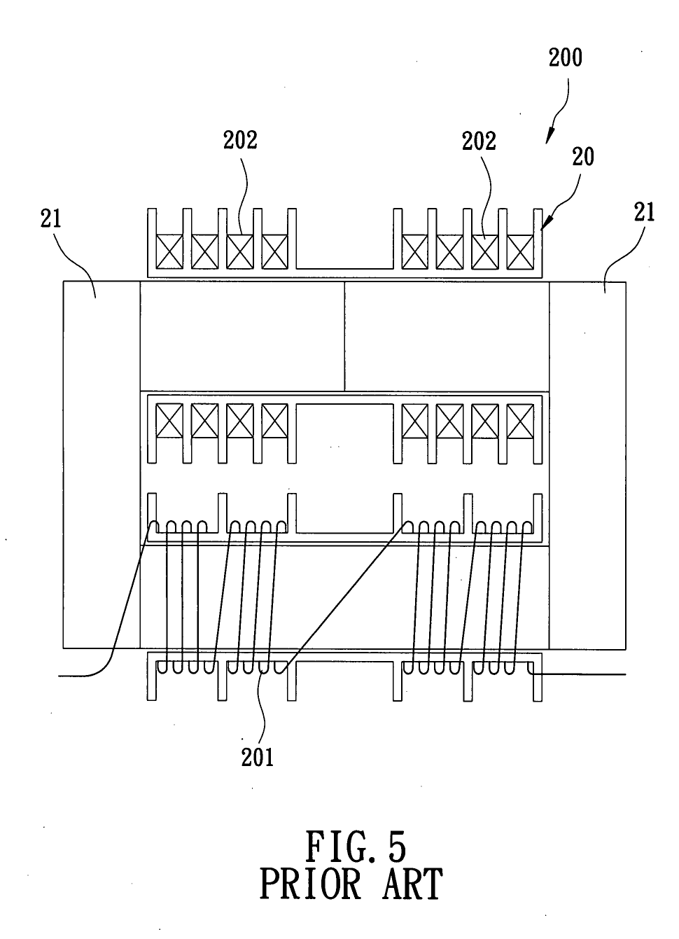

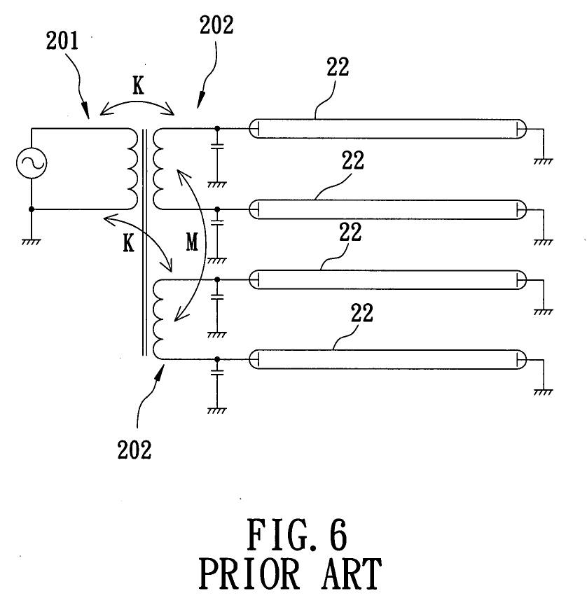

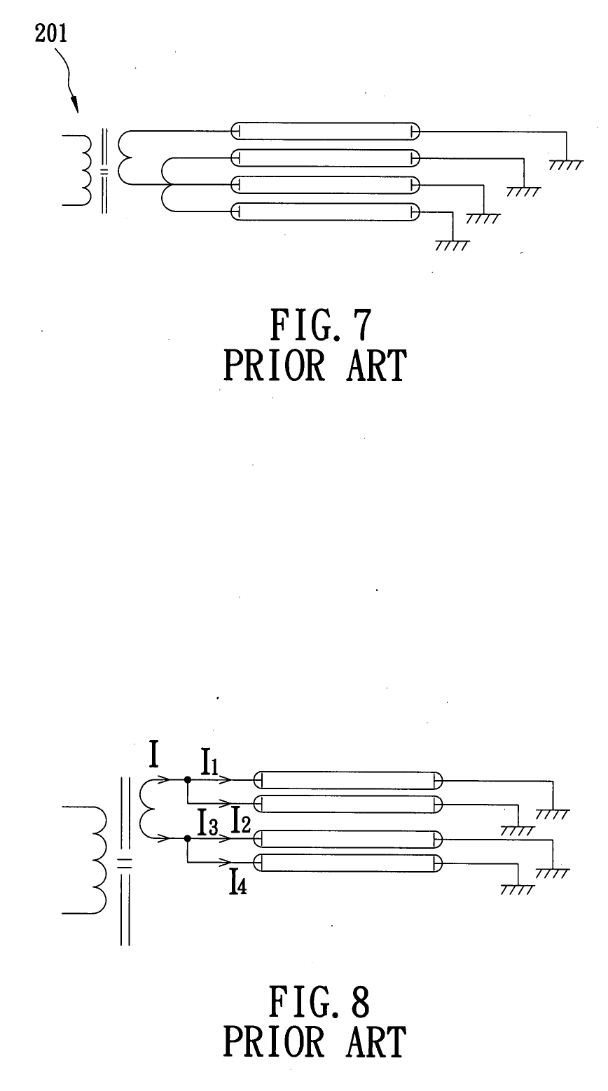

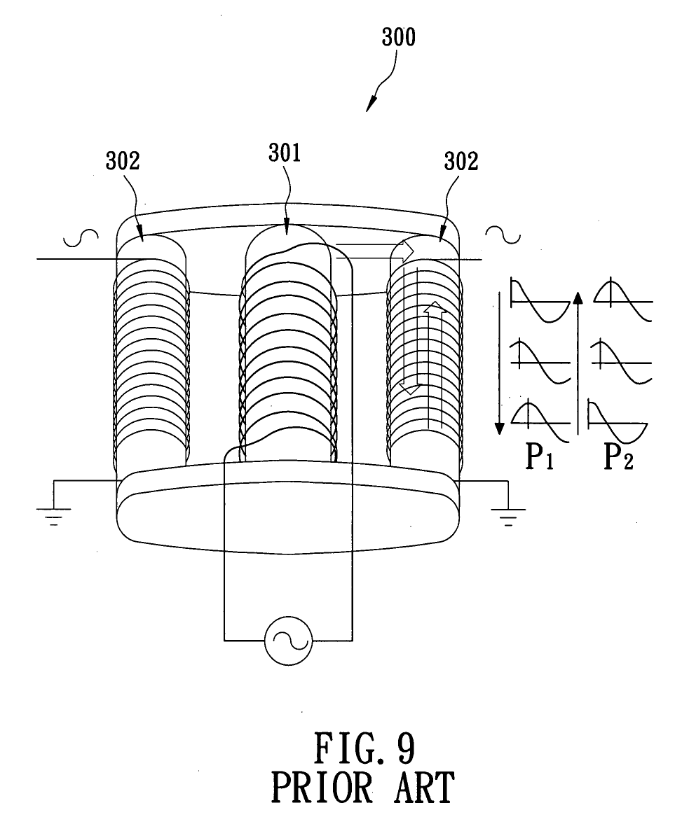

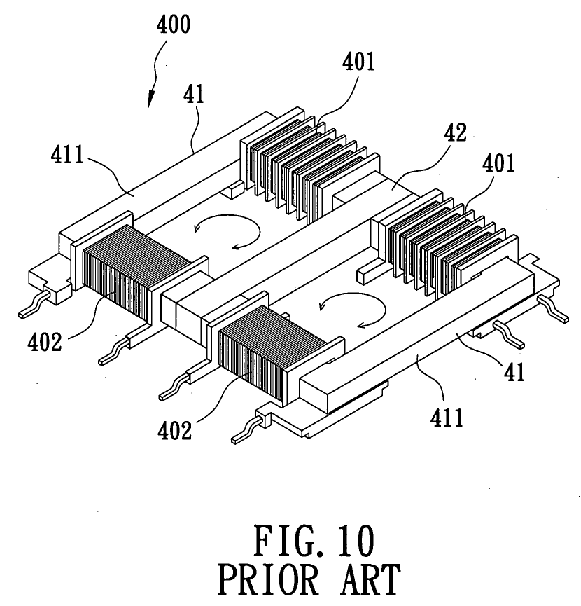

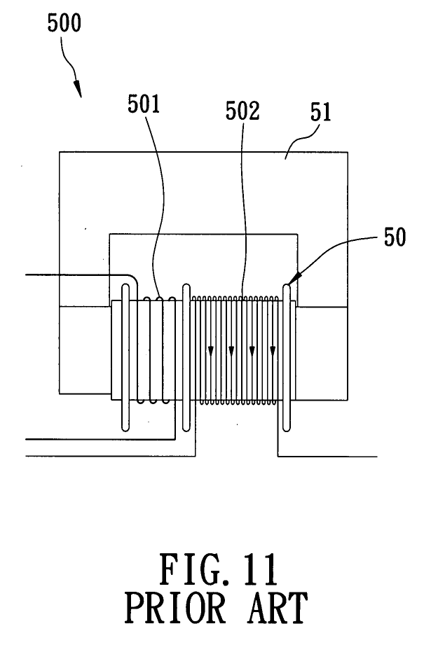

### DETAILED DESCRIPTION OF THE PREFERRED EMBODIMENTS

Before the present invention is described in greater detail, it should be noted that like elements are denoted by the same reference numerals throughout the disclosure.

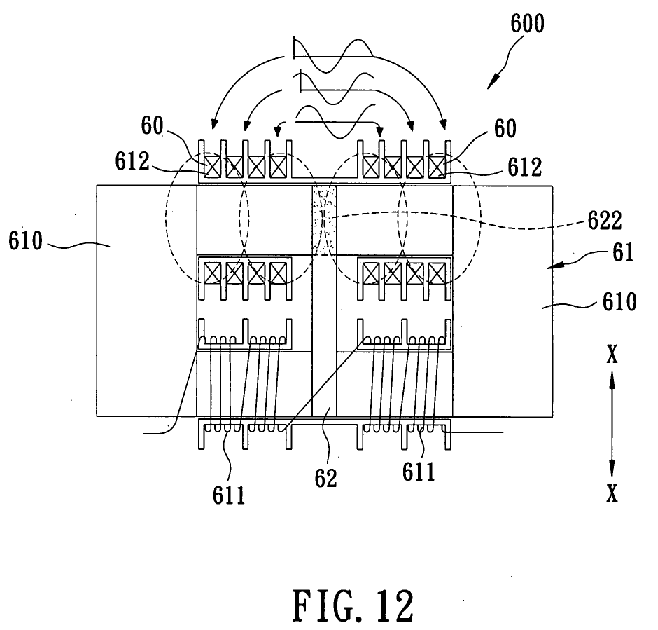

Referring to FIG. 12, according to the first preferred embodiment of the present invention, a method for adjusting mutual inductance is adapted for use in a transformer 600. As shown in FIG. 12, in a first implementation of the first preferred embodiment, the transformer 600 includes a main core 61 and two windings 60 that are wound on the main core 61 and that have the mutual inductance established therebetween. The method includes the steps of:

(A) disposing an adjusting core 62 between the windings 60 and adjacent to the main core 61, the adjusting core 62 having a cross-sectional area smaller than that of the main core 61; and

(B) without resulting in division of flux of the mutual inductance established between the windings 60, and division of an exciting magnetic flux into a plurality of independent magnetic paths, adjusting position of the adjusting core 62 relative to the main core 61 to vary the mutual inductance established between the two windings 60.

Preferably, the cross-sectional area of the adjusting core 62 is not greater than an effective cross-sectional area of the main core 61. The main core 61 has a core portion farthest from the adjusting core 62 and having a cross-sectional area greater than the effective cross-sectional area of the main core 61.

In this embodiment, the adjusting core 62 is disposed in contact with the main core 61. A contact area 622 between the adjusting core 62 and the main core 61 is adjusted in step (B). The main core 61 is formed from two U-shaped core parts 610, and includes a first side portion on which two primary windings 611 are wound, and a second side portion opposite to the first side portion on which two secondary windings 612 are wound. The adjusting core 62 is disposed to extend across the first and second side portions and between the primary windings 611 and between the secondary windings 612. The primary windings 611 are connected directly in series to each other. In other embodiments of the invention, the primary windings 611 are connected in series via an external circuit (not shown). The position of the adjusting core 62 is adjusted by moving the adjusting core 62 along a longitudinal direction (X) to vary the mutual inductance established between the secondary windings 612. It should be noted herein that the position of the adjusting core 62 can also be adjusted to vary the mutual inductance established between the primary windings 611 in other embodiments of the present invention. Further, the adjusting core 62 can be glued to the main core 61 after adjustment of the position thereof has been completed.

By adjusting the position of the adjusting core 62, cross interference between induced fluxes in the windings 60 due to the mutual inductance established therebetween can be improved based on the following relation:

$$magnetic path length = \frac{physical distance of flux path}{cross \text{-} sectional area of core}$$

By increasing the effective magnetic path length, a major magnetic path of the transformer 600 simultaneously has loose coupling and tight coupling effects, thereby achieving the objects of balancing and stabilizing currents flowing through the windings 60.

It should be further noted that since the cross-sectional area of the core portion of the main core 61 that is farthest from the adjusting core 62 is greater than the effective cross-sectional area of the main core 61, portions of the secondary windings 612 that are proximate to the primary windings 611 have tight couplings established thereat, while portions of the secondary windings 612 that are proximate to the adjusting core 62 have loose couplings established thereat. Consequently, less traveling waves enter the transformer 600 from the core portion of the main core 61 that is farthest from the adjusting core 62, thereby minimizing the formation of standing waves.

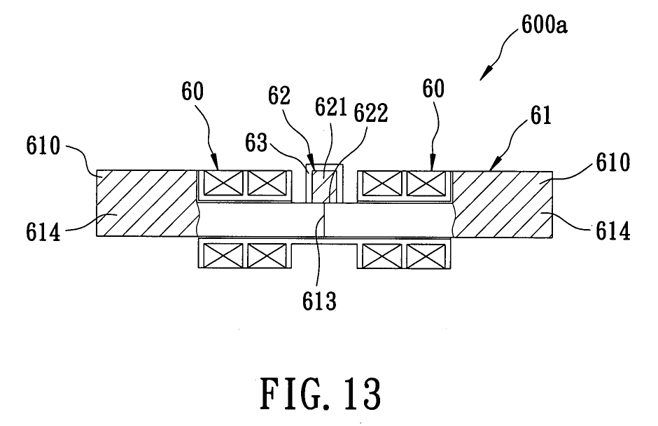

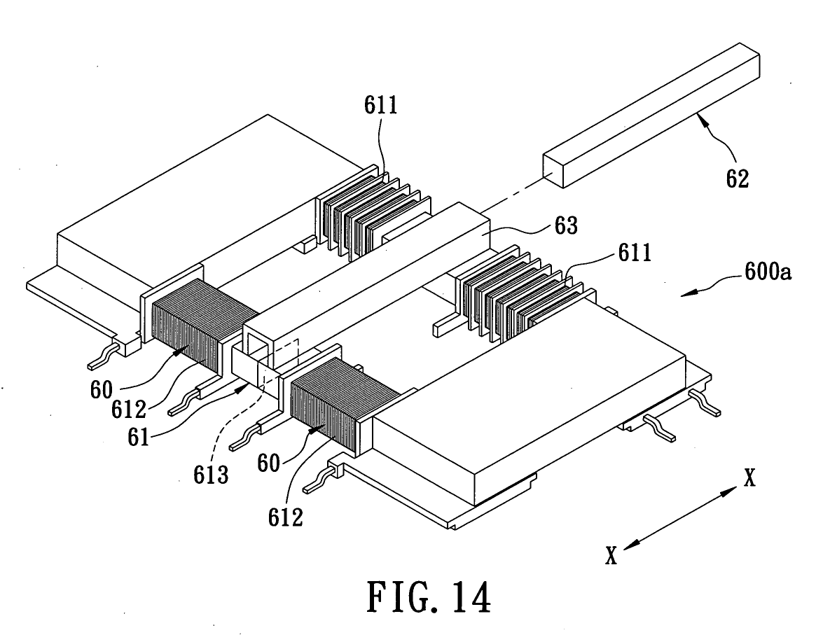

As shown in FIG. 13 and FIG. 14, in a second implementation of the first preferred embodiment, the transformer 600a further include a rack body 63, which is disposed to extend across the first and second side portions of the main core 61 in the longitudinal direction (X), and which is n-shaped. The adjusting core 62 extends through the rack body 63, and is slidable therein along the longitudinal direction (X) when adjusting the position of the adjusting core 62 relative to the main core 61. In addition, numeral 621 denotes the cross-sectional area of the adjusting core 62, numerals 614 denote the cross-sectional areas of the core portions of the main core 61 that are farthest from the adjusting core 62, and numeral 613 denotes the effective cross-sectional area of the main core 61.

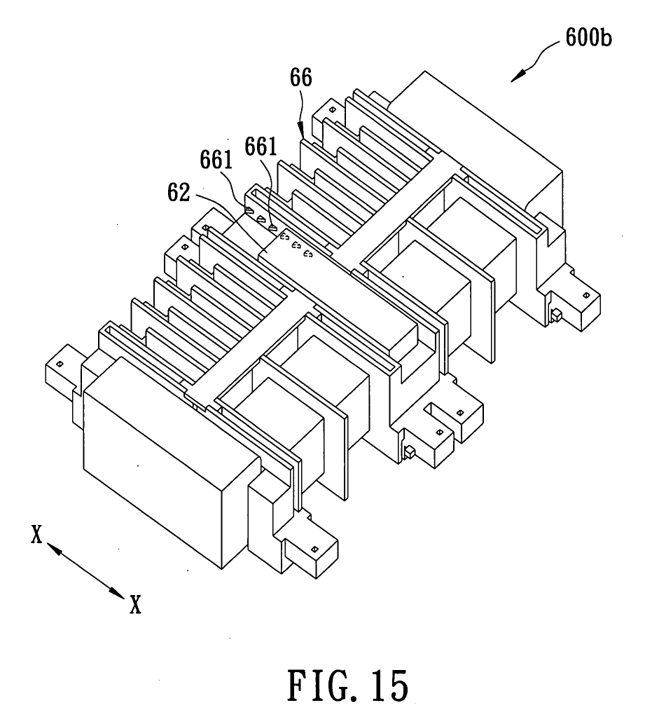

As shown in FIG. 15, in a third implementation of the first preferred embodiment, the transformer 600b further includes a coil bracket 66 that is disposed to cover the main core 61, and that has the primary and secondary windings (not shown) wound thereon. The coil bracket 66 includes a plurality of projections 661 for positioning the adjusting core 62 in a center of the coil bracket 66. The position of the adjusting core 62 relative to the main core 61 is adjusted by exerting an external force in the longitudinal direction (X) sufficient to overcome the force applied by the projections 661 to the adjusting core 62.

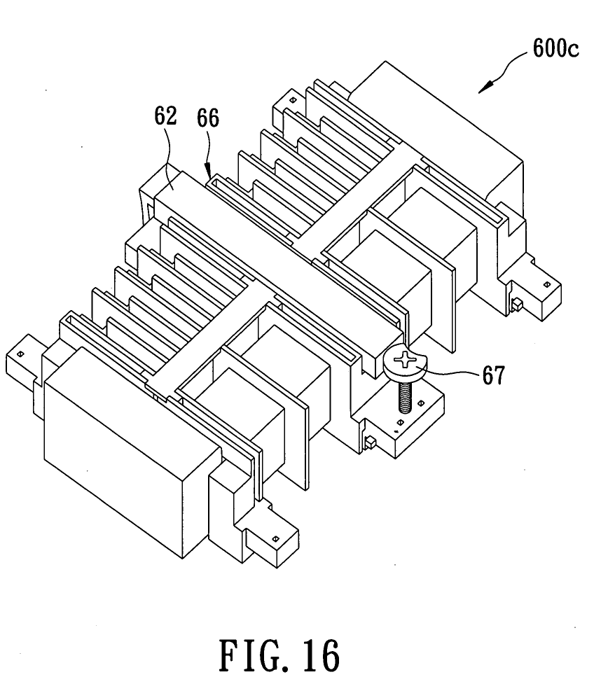

As shown in FIG. 16, a transformer 600c according to a fourth implementation of the first preferred embodiment differs from the third implementation in that the transformer 600c further includes a screw bolt 67 disposed at the center of an open side of the coil bracket 66. The screw bolt 67 abuts against the adjusting core 62, and has varying radial dimensions. The position of the adjusting core 62 relative to the main core 61 is adjusted by rotating the screw bolt 67 such that the adjusting core 62 is pushed by the screw bolt 67 to slide along the coil bracket 66.

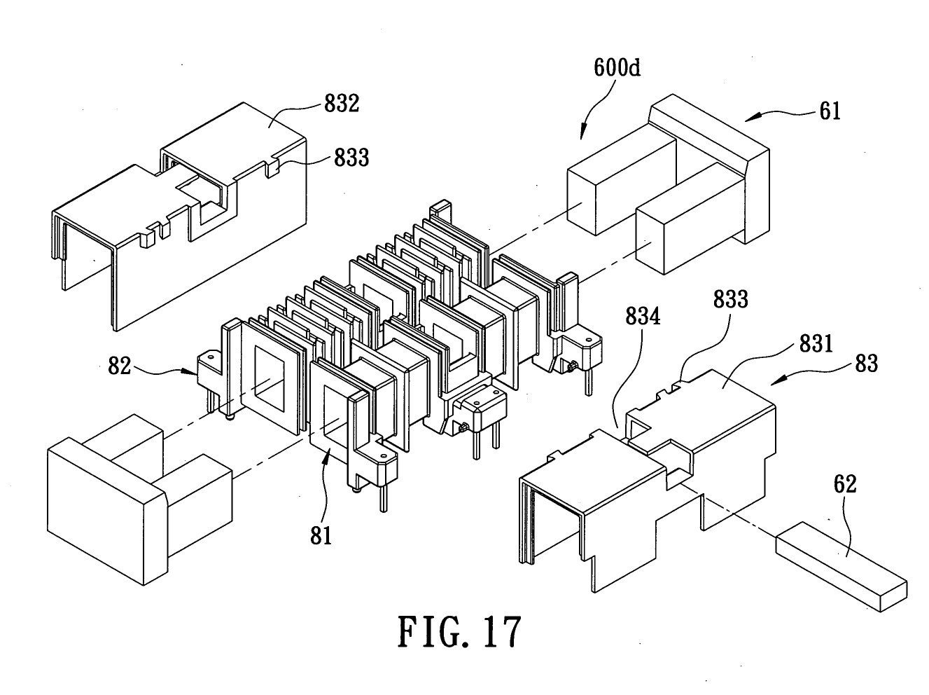

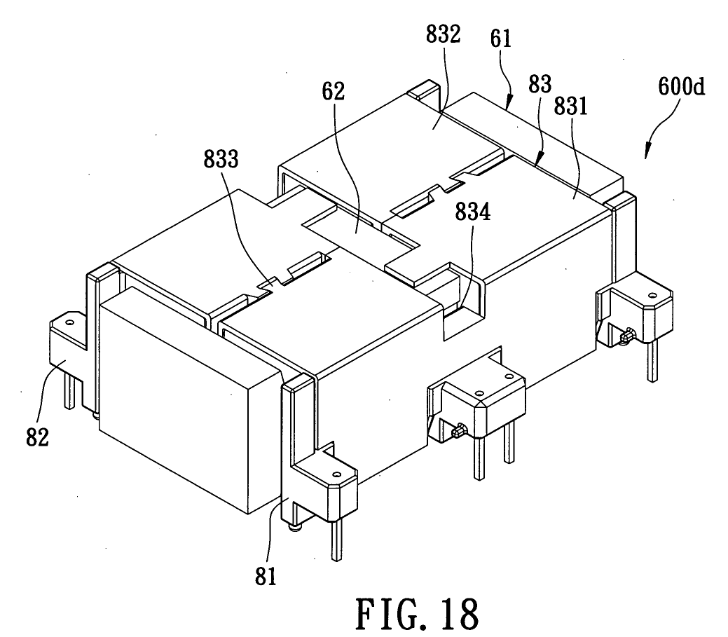

As shown in FIG. 17 and FIG. 18, a transformer 600d according to a fifth implementation of the first preferred embodiment differs from the first implementation in that the transformer 600d further includes first and second coil brackets 81, 82 that are disposed to surround the main core 61, i.e., the main core 61 extends through the first and second coil brackets 81, 82, and a coupling frame 83 that couples the first and second coil brackets 81, 82 together. The primary and secondary windings (not shown) are wound on the first and second coil brackets 81, 82, respectively. The coupling frame 83 includes a first frame body 831 coupled to the first coil bracket 81, and a second frame body 832 coupled to the second coil bracket 82. The first and second frame bodies 831, 832 are coupled to each other. The coupling frame 83 is formed with an extension space 834 that extends from the first frame body 831 to the second frame body 832. In this embodiment, the first and second frame bodies 831, 832 are coupled to each other via a plurality of male and female block structures 833 formed thereon.

The adjusting core 62 extends through the coupling frame 83, and is disposed in the extension space 834. The position of the adjusting core 62 relative to the main core 61 is adjusted by pushing the adjusting core 62 such that the adjusting core 62 slides in the extension space 834 so as to vary the mutual inductance established between the windings, e.g., the secondary windings (not shown) in this embodiment.

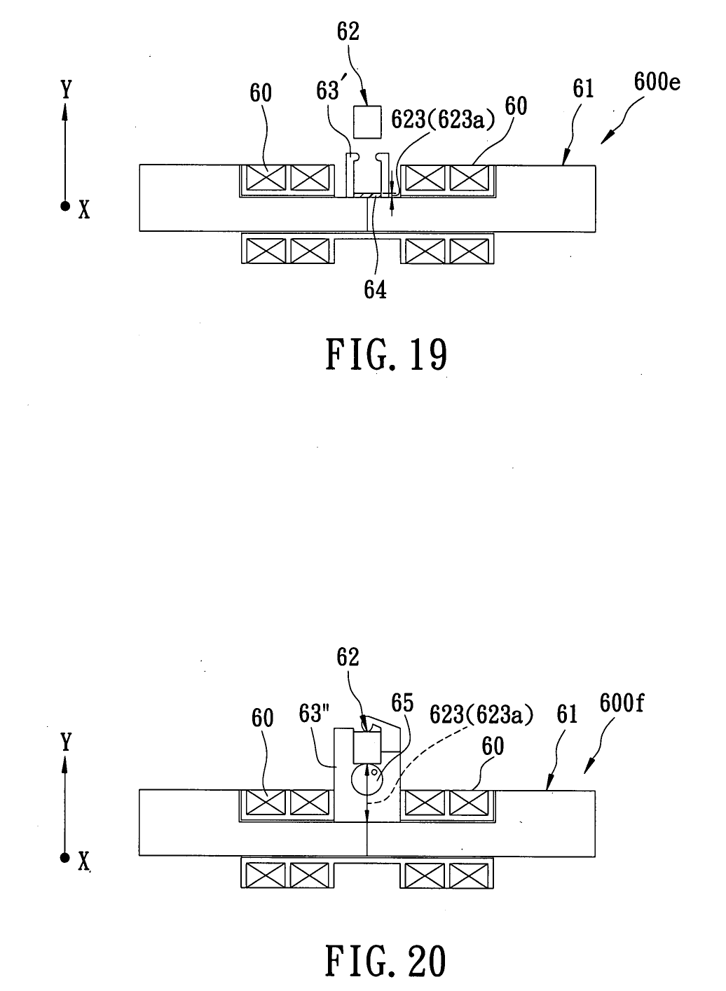

Referring to FIG. 19 and FIG. 20, according to the second preferred embodiment of the present invention, the method for adjusting mutual inductance differs from the first preferred embodiment in the manner in which the position of the adjusting core 62 relative to the main core 61 is adjusted. In this embodiment, size of an air gap 623 between the adjusting core 62 and the main core 61 is adjusted in step (B).

In a first implementation of the second preferred embodiment shown in FIG. 19, other than the main core 61, the adjusting core 62, and the windings 60, the transformer 600e further includes a rack body 63′ and an insulating washer 64. The rack body 63′ has the adjusting core 62 extending therethrough. The insulating washer 64 is disposed in the rack body 63′ between the main core 61 and the adjusting core 62. The position of the adjusting core 62 relative to the main 61 is adjusted by adjusting the size of the air gap 623 between the main core 61 and the adjusting core 62 in a vertical direction (Y) perpendicular to the longitudinal direction (X) (the air gap 623 is also referred to as a vertical air gap 623a). The insulating washer 64 provides the air gap 623 between the main core 61 and the adjusting core 62, i.e., the size of the vertical air gap 623a is equal to the thickness of the insulating washer 64. Therefore, by adjusting the thickness of the insulating washer 64, the size of the vertical air gap 623a is adjusted.

In a second implementation of the second preferred embodiment shown in FIG. 20, the transformer 600f further includes a rack body 63″ extending across the first and second side portions of the main core 61, and an eccentric wheel 65 that is disposed rotatably on the rack body 63″. The adjusting core 62 is disposed to abut against the eccentric wheel 65, and the air gap 623 extends in the vertical direction (Y) (the air gap 623 is also referred to as the vertical air gap 623a). By rotating the eccentric wheel 65, the adjusting core 62 is moved relative to the main core 61, thereby adjusting the size of the air gap 623.

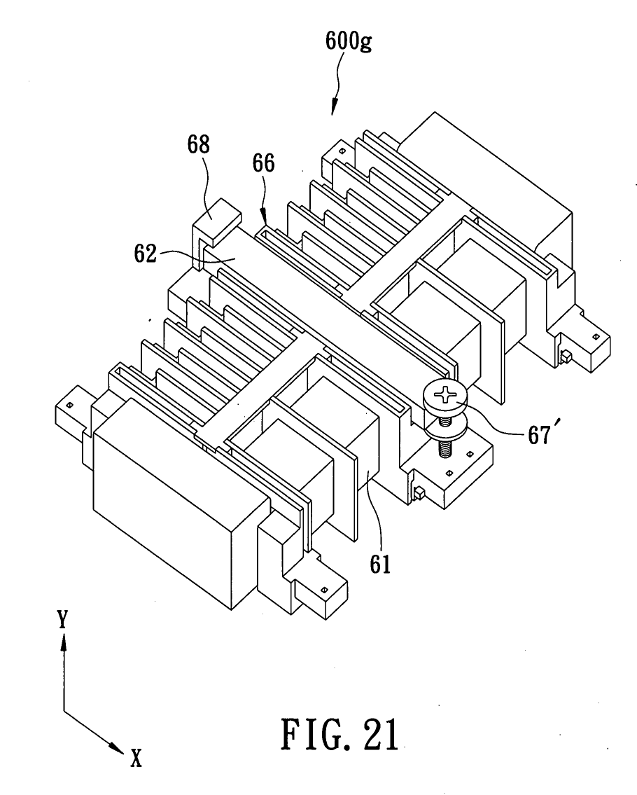

As shown in FIG. 21, in a third implementation of the second preferred embodiment, other than the main core 61, the adjusting core 62, and the windings (not shown), the transformer 600g further includes a coil bracket 66, a biasing member 68, and a screw bolt 67′. The coil bracket 66 is disposed to cover the main core 61, has the windings (not shown) wound thereon, and is formed with a groove. The biasing member 68 is disposed at one side of the groove. The screw bolt 67′ is disposed at another side of the groove. The adjusting core 62 is disposed in the groove and between the biasing member 68 and the screw bolt 67′. The position of the adjusting core 62 relative to the main core 61 is adjusted in terms of the size of the air gap (not shown) between the adjusting core 62 and the main core 61 by rotating the screw bolt 67′ such that the adjusting core 62 pivots about the biasing member 68 in the vertical direction (Y).

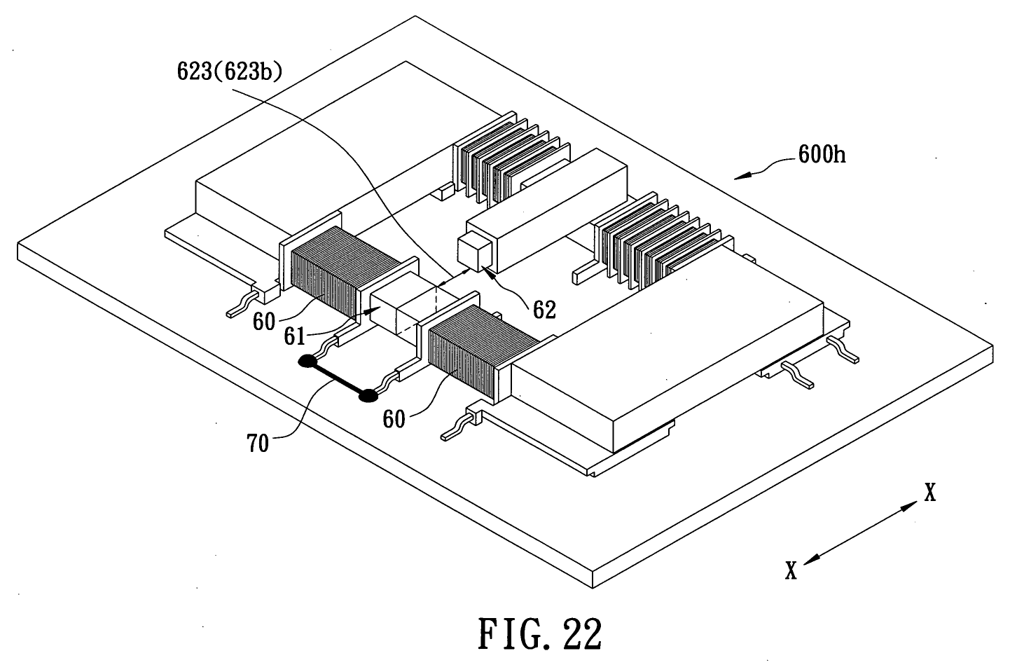

As shown in FIG. 22, according to a fourth implementation of the second preferred embodiment, in the transformer 600h, the position of the adjusting core 62 relative to the main core 61 is adjusted by adjusting the size of the air gap 623 between the adjusting core 62 and the main core 61 in the longitudinal direction (X) (The air gap 623 is also referred to as a horizontal air gap 623b). The size of the longitudinal air gap 623b is adjusted by moving the adjusting core 62 along the longitudinal direction (X) relative to the portion of the main core 61 that has the windings 60 wound thereon. It should be noted herein that the windings 60 are connected in series via an external circuit 70 configured on a circuit board in this implementation.

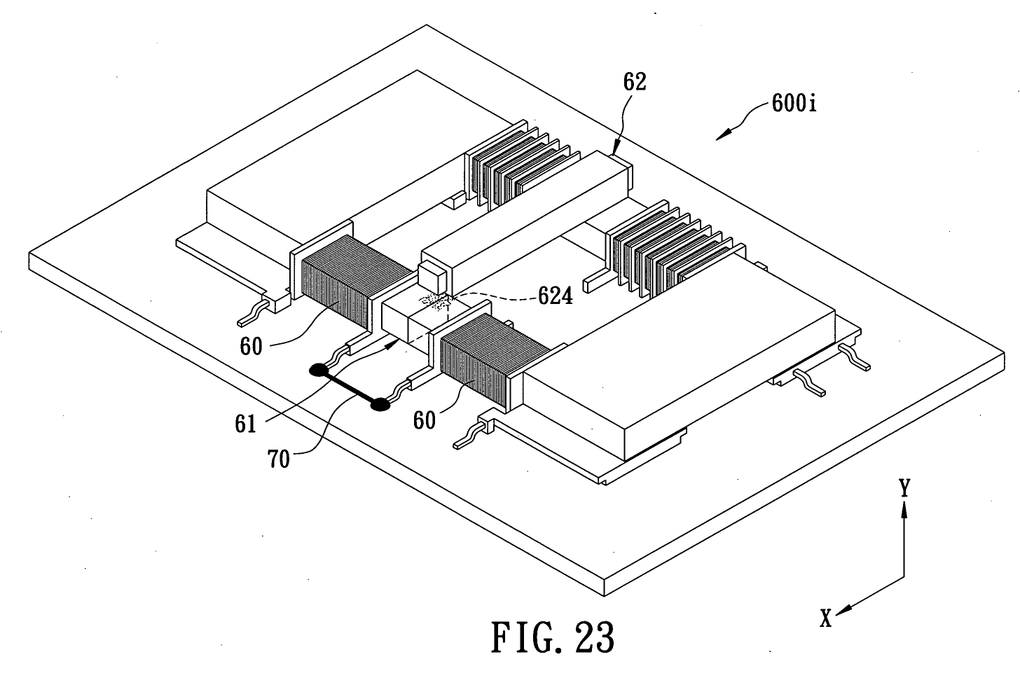

As shown in FIG. 23, according to the third preferred embodiment of the present invention, the method for adjusting mutual inductance differs from the first preferred embodiment also in the manner in which the position of the adjusting core 62 relative to the main core 61 is adjusted. In a first implementation of the third preferred embodiment shown in FIG. 23, the transformer 600i has an air gap formed between the adjusting core 62 and the main core 61 in the vertical direction (Y). A projection area 624 of the adjusting core 62 on the main core 61 is adjusted in step (B) by moving the adjusting core 62 along the longitudinal direction (X).

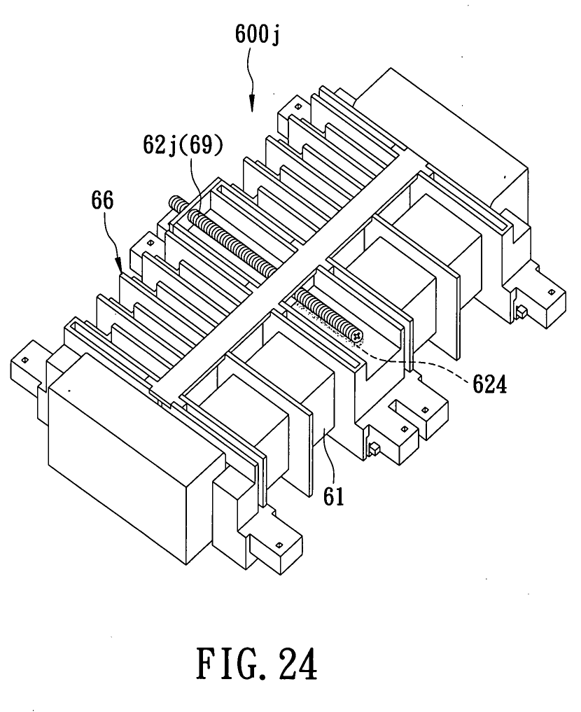

As shown in FIG. 24, in a second implementation of the third preferred embodiment, other than the main core 61, the adjusting core 62j, and the windings (not shown), the transformer 600j further includes a coil bracket 66 that is disposed to cover the main core 61, that has the windings wound thereon, and that is formed with a groove. The adjusting core 62j is an elongated screw 69 that extends through the coil bracket 66 and that is disposed in the groove. The position of the adjusting core 62j relative to the main core 61 is adjusted by adjusting the projection area 624, which is achieved through rotating the elongated screw 69 into and out of the groove.

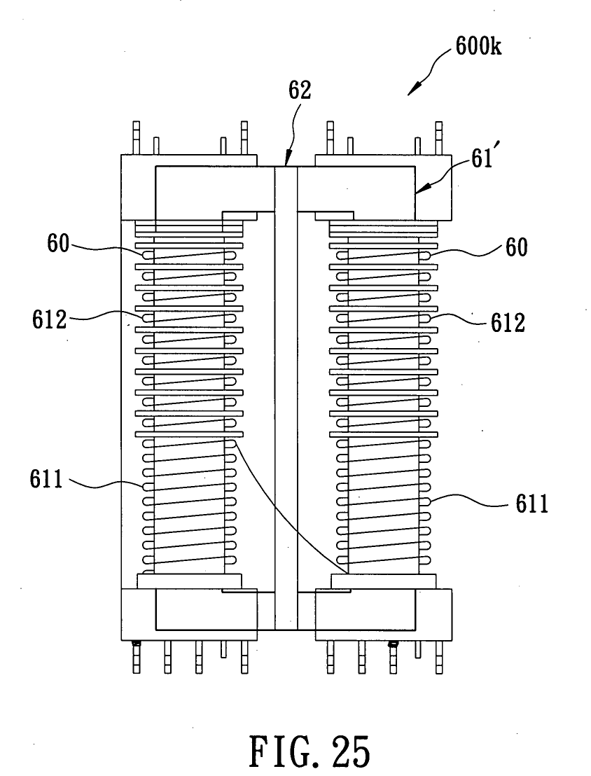

As shown in FIG. 25, according to the fourth preferred embodiment of a transformer 600k of the present invention, the main core 61′ of the transformer 600k includes opposite first and second side portions. Each of the first and second side portions has a primary winding 611 and a secondary winding 612 wound thereon. The adjusting core 62 is disposed to extend between the first and second side portions. The position of the adjusting core 62 is adjusted to vary the mutual inductance established between the secondary windings 612, i.e., the secondary windings 612 serve as the windings 60 in this embodiment. However, it should be noted herein that the primary windings 611 can also serve as the windings 60 in other embodiments, where the mutual inductance established between the primary windings 611 is varied by adjusting the position of the adjusting core 62. The position of the adjusting core 62 relative to the main core 61′ can be adjusted in manners identical to those disclosed hereinabove in connection with the previous embodiments.

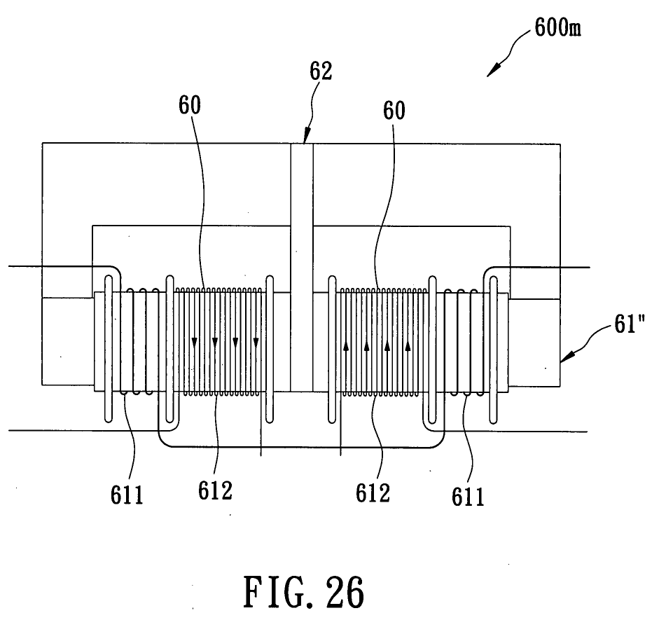

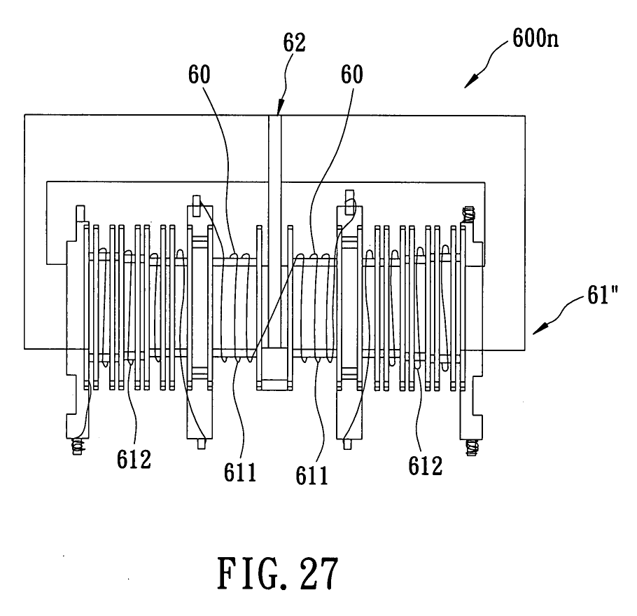

As shown in FIG. 26 and FIG. 27, according to the fifth preferred embodiment of the present invention, primary and secondary windings 611, 612 are wound on a same side of the main core 61″. In particular, the main core 61″ of the transformer 600m, 600n includes a first side portion on which the primary and secondary windings 611, 612 are wound, and a second side portion opposite to the first side portion. In a first implementation of the fifth preferred embodiment shown in FIG. 26, the secondary windings 612 are interposed between the primary windings 611. The primary windings 611 are connected to each other in series. The adjusting core 62 is disposed to extend across the first and second side portions and between the secondary windings 612. The position of the adjusting core 62 relative to the main core 61″ is adjusted to vary the mutual inductance established between the secondary windings 612, i.e., the secondary windings 612 serve as the windings 60 in this implementation. In a second implementation of the fifth preferred embodiment shown in FIG. 21, the primary windings 611 are interposed between the secondary windings 612 and are connected to each other in series. The adjusting core 62 is disposed to extend across the first and second side portions and between the primary windings 611. The position of the adjusting core 62 relative to the main core 61″ is adjusted to vary the mutual inductance established between the primary windings 611, i.e., the primary windings 611 serve as the windings 60 in this implementation.

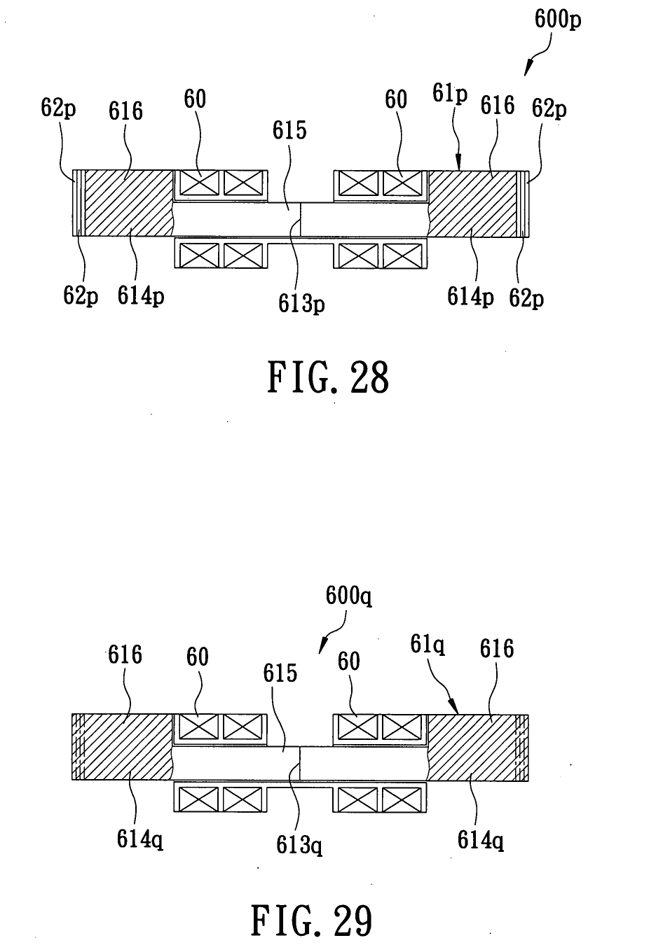

As shown in FIG. 28 and FIG. 29, the sixth preferred embodiment of the present invention differs from the first preferred embodiment in that the sixth preferred embodiment utilizes the magnetic conductivity characteristic of the main core for achieving the adjustment of the mutual inductance. In particular, tight coupling is established when permeability of the main core is high, effective cross-sectional area of the main core is large, and magnetic reluctance of the main core is low. On the other hand, loose coupling is established when the permeability of the main core is low, the effective cross-sectional area of the main core is small, and when the magnetic reluctance of the main core is high. In a transformer where magnetic coupling is established between primary and secondary windings to form an exciting loop, tight coupling needs to be formed where the primary and secondary windings are proximate to each other so as to increase efficiency of the transformer, and loose coupling needs to be formed where the two primary windings and two secondary windings are proximate to each other so as to avoid interference from leakage flux.

Therefore, according to the sixth preferred embodiment, the main core 61p, 61q has a loose coupling end 615, and two tight coupling ends 616 that are distal from the loose coupling end 615. Each of the tight coupling ends 616 has a reluctance smaller than that of the loose coupling end 615. Magnetic permeability of each of the tight coupling ends 616 is greater than that of the loose coupling end 615. The transformer 600p, 600q further includes two windings 60, each of which is wound on the main core 61p, 61q between the loose coupling end 615 and a respective one of the tight coupling ends 616. The two windings 60 have the mutual inductance established therebetween. In the previous embodiments, an adjusting core 62 (see FIG. 12) is disposed between the windings 60 for increasing magnetic path length, so as to achieve high reluctance and loose coupling effects between the windings 60. However, according to the sixth preferred embodiment, the method for adjusting the mutual inductance includes the step of: while maintaining a cross-sectional area 614p, 614q of each of the tight coupling ends 616 to be greater than an effective cross-sectional area 613p, 613q of the loose coupling end 615, adjusting the cross-sectional areas 614p, 614q of the tight coupling ends 616 to vary the mutual inductance established between the two windings 60. The cross-sectional areas 614p, 614q of the tight coupling ends can be adjusted in different ways.

In a first implementation of the sixth preferred embodiment shown in FIG. 28, a plurality of adjusting cores 62p are disposed on the tight coupling ends 616 to adjust the cross-sectional areas 614p of the tight coupling ends 616, such that the reluctances at the tight coupling ends 616 are lowered, thereby forming tighter magnetic couplings at the tight coupling ends 616, and looser magnetic couplings at the loose coupling end 615. Consequently, the mutual inductance between the windings 60 is reduced, and formation of standing waves is avoided. Preferably, the cross-sectional areas 614p of the tight coupling ends 616 are at least 1.2 times the effective cross-sectional area 613p of the loose coupling end 615.

According to a second implementation of the sixth preferred embodiment shown in FIG. 29, in the transformer 600q, core portions of the tight coupling ends 616 are removed by grinding so as to adjust the cross-sectional areas 614q of the tight coupling ends 616. The main core 61q can be purposely made larger to provide room for subsequent grinding.

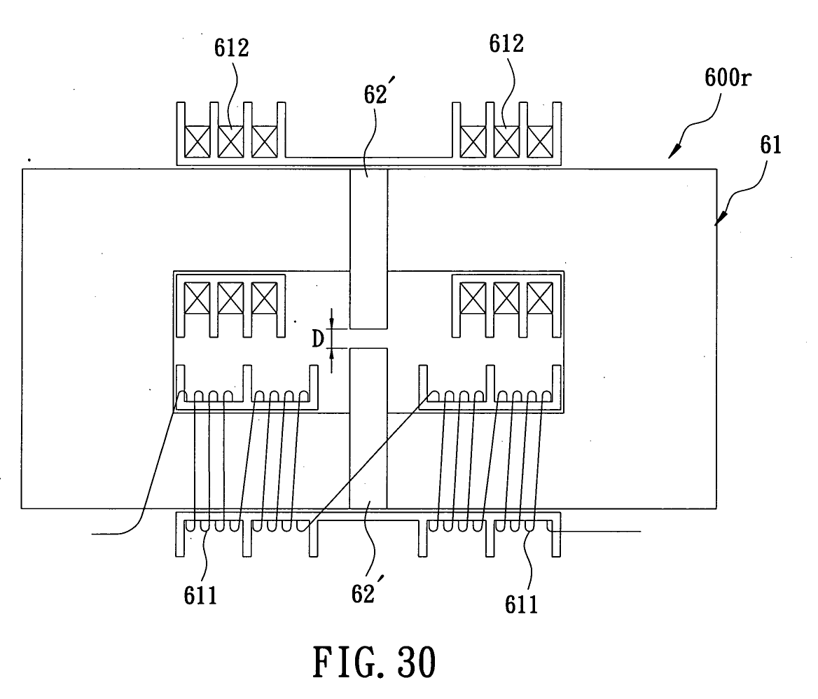

As shown in FIG. 30, according to the seventh preferred embodiment of a transformer 600r of the present invention, the transformer 600r is provided with two of the adjusting cores 62′, as opposed to one in the first preferred embodiment (see FIG. 12), for adjusting the mutual inductance. The main core 61 includes a first side portion on which primary windings 611 are wound, and a second side portion opposite to the first side portion on which secondary windings 612 are wound. In step (A), the two adjusting cores 62′ are respectively disposed between the primary windings 611 and the secondary windings 612 and adjacent to the main core 61. In step (B), a distance (D) between the two adjusting cores 62′ is adjusted.

In sum, as is evident from the various embodiments disclosed above, with reference to FIG. 12 and FIG. 28, the present invention is capable of adjusting mutual inductance established between two windings 60, whether the windings 60 are primary windings 611 or secondary windings 612, by adjusting the position of the adjusting core 62 relative to the main core 61 without resulting in division of flux of the mutual inductance established between the windings 60, and division of an exciting magnetic flux into a plurality of independent magnetic paths, or by adjusting the cross-sectional areas 614p of the tight coupling ends 616 of the main core 61p while maintaining the cross-sectional area 614p of each of the tight coupling ends 616 to be greater than an effective cross-sectional area 613p of the loose coupling end 615 of the main core 61p. Consequently, the currents flowing through the windings 60 can be balanced and stabilized, thereby achieving the object of the present invention.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A method for adjusting mutual inductance adapted for use in a transformer including a main core and two windings that are wound on the main core and that have the mutual inductance established therebetween, said method comprising the steps of:
(A) disposing an adjusting core between the windings and adjacent to the main core, the adjusting core having a cross-sectional area smaller than that of the main core; and
(B) without resulting in division of flux of the mutual inductance established between the windings, and division of an exciting magnetic flux into a plurality of independent magnetic paths, adjusting position of the adjusting core relative to the main core to vary the mutual inductance established between the two windings.

2. The method for adjusting mutual inductance as claimed in claim 1, wherein the cross-sectional area of the adjusting core is not greater than an effective cross-sectional area of the main core.

3. The method for adjusting mutual inductance as claimed in claim 1, wherein the main core has a core portion farthest from the adjusting core and having a cross-sectional area greater than an effective cross-sectional area of the main core.

4. The method for adjusting mutual inductance as claimed in claim 1, wherein the windings are connected in series to each other.

5. The method for adjusting mutual inductance as claimed in claim 1, wherein the windings are connected in series via an external circuit.

6. The method for adjusting mutual inductance as claimed in claim 1, wherein the main core includes a first side portion on which primary windings are wound, and a second side portion opposite to the first side portion on which secondary windings are wound, the adjusting core being disposed to extend across the first and second side portions and between the primary windings, the position of the adjusting core being adjusted to vary the mutual inductance established between the primary windings.

7. The method for adjusting mutual inductance as claimed in claim 1, wherein the main core includes a first side portion on which primary windings are wound, and a second side portion opposite to the first side portion on which secondary windings are wound, the adjusting core being disposed to extend across the first and second side portions and between the secondary windings, the position of the adjusting core being adjusted to vary the mutual inductance established between the secondary windings.

8. The method for adjusting mutual inductance as claimed in claim 1, wherein the main core includes a first side portion on which primary and secondary windings are wound, and a second side portion opposite to the first side portion, the adjusting core being disposed to extend across the first and second side portions and between the primary windings, the position of the adjusting core being adjusted to vary the mutual inductance established between the primary windings.

9. The method for adjusting mutual inductance as claimed in claim 1, wherein the main core includes opposite first and second side portions, each having a primary winding and a secondary winding wound thereon, the adjusting core being disposed to extend between the first and second side portions, the position of the adjusting core being adjusted to vary the mutual inductance established between the secondary windings.

10. The method for adjusting mutual inductance as claimed in claim 1, wherein the main core includes a first side portion on which primary and secondary windings are wound, and a second side portion opposite to the first side portion, the primary windings being interposed between the secondary windings and being connected to each other in series, the adjusting core being disposed to extend across the first and second side portions and between the primary windings, the position of the adjusting core being adjusted to vary the mutual inductance established between the primary windings.

11. The method for adjusting mutual inductance as claimed in claim 1, wherein the main core includes a first side portion on which primary and secondary windings are wound, and a second side portion opposite to the first side portion, the secondary windings being interposed between the primary windings, the primary windings being connected to each other in series, the adjusting core being disposed to extend across the first and second side portions and between the secondary windings, the position of the adjusting core being adjusted to vary the mutual inductance established between the secondary windings.

12. The method for adjusting mutual inductance as claimed in claim 1, wherein a contact area between the adjusting core and the main core is adjusted in step (B).

13. The method for adjusting mutual inductance as claimed in claim 1, wherein size of an air gap between the adjusting core and the main core is adjusted in step (B).

14. The method for adjusting mutual inductance as claimed in claim 1, wherein an air gap is formed between the adjusting core and the main core, and a projection area of the adjusting core on the main core is adjusted in step (B).

15. The method for adjusting mutual inductance as claimed in claim 1, wherein:
the main core includes a first side portion on which primary windings are wound, and a second side portion opposite to the first side portion on which secondary windings are wound;
in step (A), two of the adjusting cores are respectively disposed between the primary windings and the secondary windings and adjacent to the main core; and
in step (B), a distance between the two adjusting cores is adjusted.

16. A method for adjusting mutual inductance adapted for use in a transformer including a main core, the main core having a loose coupling end, and two tight coupling ends that are distal from the loose coupling end, each of the tight coupling ends having a reluctance smaller than that of the loose coupling end, the transformer further including two windings, each of which is wound on the main core between the loose coupling end and a respective one of the tight coupling ends, the two windings having the mutual inductance established therebetween, said method comprising the step of:
while maintaining a cross-sectional area of each of the tight coupling ends to be greater than an effective cross-sectional area of the loose coupling end, adjusting the cross-sectional areas of the tight coupling ends to vary the mutual inductance established between the two windings.

17. The method for adjusting mutual inductance as claimed in claim 16, wherein adjusting cores are disposed on the tight coupling ends to adjust the cross-sectional areas of the tight coupling ends.

18. The method for adjusting mutual inductance as claimed in claim 16, wherein core portions of the tight coupling ends are removed by grinding to adjust the cross-sectional areas of the tight coupling ends.

19. The method for adjusting mutual inductance as claimed in claim 16, wherein the cross-sectional area of each of the tight coupling ends is at least 1.2 times of the effective cross-sectional area of the loose coupling end.

20. The method for adjusting mutual inductance as claimed in claim 16, wherein magnetic permeability of each of the tight coupling ends is greater than that of the loose coupling end.

21. A transformer capable of adjusting mutual inductance, comprising:
a main core;
two windings wound on said main core and having the mutual inductance established therebetween; and
an adjusting core having a cross-sectional area smaller than that of said main core, and disposed between said windings and adjacent to said main core;
wherein position of said adjusting core relative to said main core is adjustable so as to vary the mutual inductance established between said windings.

22. The transformer capable of adjusting mutual inductance as claimed in claim 21, wherein the cross-sectional area of said adjusting core is not greater than an effective cross-sectional area of said main core.

23. The transformer capable of adjusting mutual inductance as claimed in claim 21, wherein said main core has a core portion farthest from said adjusting core and having a cross-sectional area greater than an effective cross-sectional area of said main core.

24. The transformer capable of adjusting mutual inductance as claimed in claim 21, wherein said windings are connected in series to each other.

25. The transformer capable of adjusting mutual inductance as claimed in claim 21, wherein said windings are connected in series via an external circuit.

26. The transformer capable of adjusting mutual inductance as claimed in claim 21, wherein said windings are primary windings, said transformer further comprising secondary windings, said main core including a first side portion on which said primary windings are wound, and a second side portion opposite to said first side portion on which said secondary windings are wound, said adjusting core being disposed to extend across said first and second side portions and between said primary windings, the position of said adjusting core being adjusted to vary the mutual inductance established between said primary windings.

27. The transformer capable of adjusting mutual inductance as claimed in claim 21, wherein said windings are secondary windings, said transformer further comprising primary windings, said main core including a first side portion on which said primary windings are wound, and a second side portion opposite to said first side portion on which said secondary windings are wound, said adjusting core being disposed to extend across said first and second side portions and between said secondary windings, the position of said adjusting core being adjusted to vary the mutual inductance established between said secondary windings.

28. The transformer capable of adjusting mutual inductance as claimed in claim 21, wherein said windings are primary windings, said transformer further comprising secondary windings, said main core including a first side portion on which said primary and secondary windings are wound, and a second side portion opposite to said first side portion, said adjusting core being disposed to extend across said first and second side portions and between said primary windings, the position of said adjusting core being adjusted to vary the mutual inductance established between said primary windings.

29. The transformer capable of adjusting mutual inductance as claimed in claim 21, wherein said windings are secondary windings, said transformer further comprising primary windings, said main core including opposite first and second side portions, each having one of said primary windings and one of said secondary windings wound thereon, said adjusting core being disposed to extend between said first and second side portions, the position of said adjusting core being adjusted to vary the mutual inductance established between said secondary windings.

30. The transformer capable of adjusting mutual inductance as claimed in claim 21, wherein said windings are primary windings, said transformer further comprising secondary windings, said main core including a first side portion on which said primary and secondary windings are wound, and a second side portion opposite to said first side portion said primary windings being interposed between said secondary windings and being connected to each other in series, said adjusting core being disposed to extend across said first and second side portions and between said primary windings, the position of said adjusting core being adjusted to vary the mutual inductance established between said primary windings.

31. The transformer capable of adjusting mutual inductance as claimed in claim 21, wherein said windings are secondary windings, said transformer further comprising primary windings, said main core including a first side portion on which said primary and secondary windings are wound, and a second side portion opposite to said first side portion said secondary windings being interposed between said primary windings, said primary windings being connected to each other in series, said adjusting core being disposed to extend across said first and second side portions and between said secondary windings, the position of said adjusting core being adjusted to vary the mutual inductance established between said secondary windings.

32. The transformer capable of adjusting mutual inductance as claimed in claim 21, wherein said adjusting core and said main core have a contact area therebetween, the contact area being adjusted to vary the mutual inductance.

33. The transformer capable of adjusting mutual inductance as claimed in claim 21, wherein said adjusting core and said main core have an air gap therebetween, size of the air gap being adjusted to vary the mutual inductance.

34. The transformer capable of adjusting mutual inductance as claimed in claim 21, wherein said adjusting core and said main core have an air gap formed therebetween, and a projection area of said adjusting core on said main core is adjusted to vary the mutual inductance.

35. The transformer capable of adjusting mutual inductance as claimed in claim 21, wherein said main core has opposite first and second side portions, said transformer further comprising a rack body that is disposed to extend across said first and second side portions of said main core, said adjusting core extending through said rack body.

36. The transformer capable of adjusting mutual inductance as claimed in claim 21, further comprising an insulating washer that is disposed between said main core and said adjusting core.

37. The transformer capable of adjusting mutual inductance as claimed in claim 21, wherein said main core includes opposite first and second side portions, said transformer further comprising a rack body that is disposed to extend across said first and second side portions, and an eccentric wheel that is disposed rotatably on said rack body, said adjusting core being disposed to abut against said eccentric wheel.

38. The transformer capable of adjusting mutual inductance as claimed in claim 21, further comprising a coil bracket that is disposed to cover said main core, and that has said windings wound thereon, said coil bracket including a plurality of projections for positioning said adjusting core in a center of said coil bracket.

39. The transformer capable of adjusting mutual inductance as claimed in claim 21, further comprising a coil bracket that is disposed to cover said main core, that has said windings wound thereon, and that is formed with a groove, a biasing member that is disposed at one side of said groove, and a screw bolt that is disposed at another side of said groove, said adjusting core being disposed in said groove and between said biasing member and said screw bolt.

40. The transformer capable of adjusting mutual inductance as claimed in claim 21, further comprising a coil bracket that is disposed to cover said main core, that has said windings wound thereon, and that is formed with a groove, said adjusting core being an elongated screw that extends through said coil bracket and that is disposed in said groove.

41. The transformer capable of adjusting mutual inductance as claimed in claim 21, further comprising first and second coil brackets that are disposed to surround said main core, and a coupling frame that couples said first and second coil brackets together, said windings being wound on one of said first and second coil brackets, said adjusting core extending through said coupling frame.

42. The transformer capable of adjusting mutual inductance as claimed in claim 41, wherein said coupling frame includes a first frame body coupled to said first coil bracket, and a second frame body coupled to said second coil bracket, said first and second frame bodies being coupled to each other, said coupling frame being formed with an extension space that extends from said first frame body to said second frame body, and that has said adjusting core disposed therein.
